(19) United States
(12) Patent Application Publication
(10) Pub. No.: US 2025/0388173 A1
(43) Pub. Date: Dec. 25, 2025

(54) DISPLAY SYSTEM

(71) Applicant: TOYOTA JIDOSHA KABUSHIKI KAISHA, Toyota-shi (JP)

(72) Inventors: Kazuhisa ISHIMARU, Nagoya-shi (JP); Yusuke UEDA, Okazaki-shi (JP); Go MATSUNOBU, Okazaki-shi (JP)

(73) Assignee: TOYOTA JIDOSHA KABUSHIKI KAISHA, Toyota-shi (JP)

(21) Appl. No.: 19/201,857

(22) Filed: May 7, 2025

(30) Foreign Application Priority Data
Jun. 21, 2024 (JP) 2024-100667

(51) Int. Cl. B60R 1/24; G06V 20/56; G08G 1/16

(52) U.S. Cl. CPC B60R 1/24; G06V 20/588; G08G 1/167; B60R 2300/308; B60R 2300/804

(57) ABSTRACT

A display system is a system that displays, on a display, a lane marking of a lane in which a vehicle travels. The display system includes: a recognition and generation section configured to recognize the lane marking, based on an image captured by a camera of the vehicle, and to generate an image for display including a road shape image disposed along the lane marking; and a display control section configured to cause the display to display the image for display. The display control section is configured to estimate a cant angle of the lane, based on a result of detection by an internal sensor that detects a traveling state of the vehicle, and to correct, by using the cant angle, a position of the road shape image in the image for display.

### CROSS-REFERENCE TO RELATED APPLICATION

This application claims priority to Japanese Patent Application No. 2024-100667 filed on Jun. 21, 2024, incorporated herein by reference in its entirety.

### BACKGROUND

### 1. Technical Field

The disclosure relates to a display system.

### 2. Description of Related Art

Japanese Unexamined Patent Application Publication No. 2020-16541 (JP 2020-16541 A) describes a display controller for a vehicle. The display controller identifies the three-dimensional position of a target object relative to the vehicle by using a millimeter-wave radar, identifies the three-dimensional position of the target object relative to the vehicle by using a high-definition map, and displays a virtual image that emphasizes the target object in a superimposed manner, in alignment with the identified three-dimensional position.

### SUMMARY

For example, in in-vehicle camera-based image recognition that is used in driving assistance, autonomous driving, or the like of vehicles, there occur recognition errors. For example, in a situation where a recognition error is prominent, there is a possibility that the position of a lane marking or the like is misaligned due to the effect of the recognition error, in an image for display that is a result of the image recognition. When an attempt is made to display a target object more accurately by using a high-definition map as in the related art, there are problems, such as an increase in cost for preparing the high-definition map through actual measurement, and a room for improvement in the immediacy of an update to the high-definition map.

A display system according to one aspect of the present disclosure is a display system configured to display, on an in-vehicle display, a lane marking of a lane in which a vehicle travels. The display system includes: a recognition and generation section configured to recognize the lane marking, based on an image captured by an in-vehicle camera of the vehicle, and to generate an image for display including a road shape image disposed along the lane marking; and a display control section configured to cause a display unit of the vehicle to display the image for display. The display control section is configured to estimate a cant angle of the lane, based on a result of detection by an internal sensor that detects a traveling state of the vehicle, and to correct, by using the cant angle, the position of the road shape image in the image for display.

In the display system according to the aspect of the present disclosure, the lane marking is recognized based on the image captured by the in-vehicle camera of the vehicle. In the image for display, the position of the road shape image extending along the recognized lane marking is corrected by using the cant angle of the lane estimated based on the result of detection by the internal sensor that detects a traveling state of the vehicle. Thus, it is possible to restrain misalignment of the road shape image in the image for display that is acquired as a result of image recognition using the in-vehicle camera, while reducing an increase in cost, for example, compared to cases where a high-definition map is used.

In an embodiment, the display control section may be configured to use the vehicle speed of the vehicle, the lateral acceleration of the vehicle, and the yaw rate of the vehicle for the traveling state of the vehicle, and to estimate the cant angle of the lane at the position of the vehicle, based on an equation of motion that represents the balance between lateral force involved in a turn of the vehicle, lateral force acting on the vehicle due to the cant of the lane, and lateral force corresponding to the lateral acceleration of the vehicle. In such a case, the position of the road shape image in the image for display can be corrected by using the cant angle at the position of the vehicle estimated by using the vehicle speed of the vehicle, the lateral acceleration of the vehicle, and the yaw rate of the vehicle.

In an embodiment, the display control section may be configured to: when the cant angle estimated at the position of the vehicle is less than a predetermined cant angle threshold value and when the rate of increase in curvature of the lane marking in a predetermined section ahead of the vehicle is a predetermined increase rate threshold value or more, estimate the cant angle in such a manner that the cant angle gradually increases as the lane goes farther ahead from the position of the vehicle; and when the cant angle estimated at the position of the vehicle is the cant angle threshold value or more and when the rate of decrease in curvature of the lane marking in the predetermined section is a predetermined decrease rate threshold value or more, estimate the cant angle in such a manner that the cant angle gradually decreases as the lane goes farther ahead from the position of the vehicle. In such a case, for example, in a situation where the vehicle approaches a curve from a straight line, a large cant angle can be estimated in advance, to fit with the curve having the gradually increasing curvature. For example, in a situation where the vehicle approaches a straight line from a curve, a small cant angle can be estimated in advance, to fit with the curve having the gradually decreasing curvature.

According to the present disclosure, it is possible to restrain misalignment of a road shape image in an image for display that is acquired as a result of image recognition using an in-vehicle camera.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing an example of a configuration of a display system according to an embodiment;

FIG. 2 is a diagram for describing misalignment of lane markings in an image for display;

FIG. 3 shows an example of correction of the positions of lane markings in an image for display;

FIG. 4 is a flowchart showing an example of processing by the display system according to the embodiment; and

FIG. 5 is a flowchart showing an example of a process of estimating a cant angle in FIG. 4.

### DETAILED DESCRIPTION OF EMBODIMENTS

Hereinafter, embodiments of the present disclosure are described with reference to the drawings.

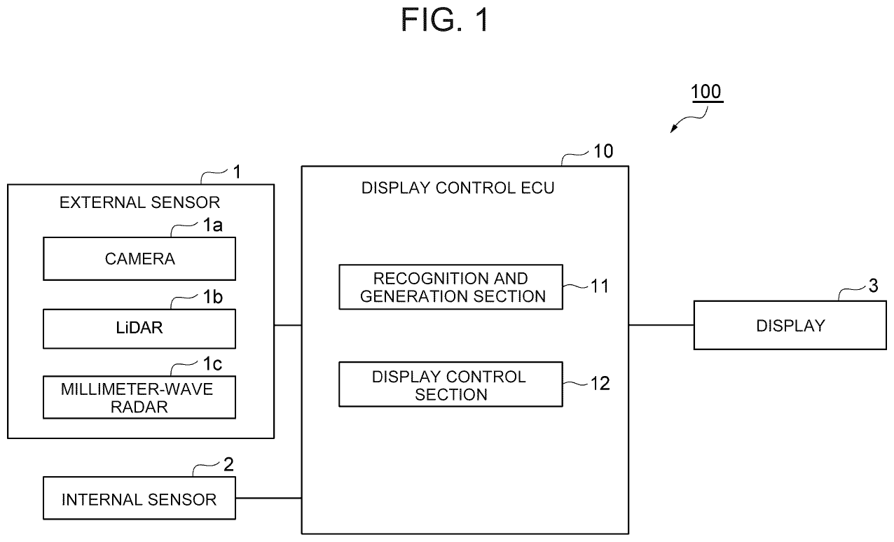

FIG. 1 is a block diagram showing a display system 100 according to an embodiment. The display system 100 shown in FIG. 1 is a system that is mounted on a vehicle, such as a passenger car or a truck, and performs image display according to a situation around the vehicle. The display system 100 displays, on an in-vehicle display, a lane marking of a lane in which the vehicle is traveling.

The lane marking displayed on the in-vehicle display is used, for example, in lane trace control (lane keeping assist (LKA)), which encourages a driver to steer a steering wheel in such a manner as not to depart from a lane in which the vehicle is traveling, and in control (lane departure warning (LDW)) of warning a driver about the possibility that the vehicle may depart from a lane. The vehicle may be configured to be able to execute an advanced drive assistance system (ADAS), including driving assistance functionality, such as LKA and LDW mentioned above, and autonomous driving functionality including velocity control.

As shown in FIG. 1, the display system 100 includes a display control electronic control unit (ECU) 10 that manages the system in a supervising manner. The display control ECU 10 is an electronic control unit including a central processing unit (CPU) and a storage unit. The storage unit is configured by using, for example, a read only memory (ROM), a random access memory (RAM), an electrically erasable programmable read-only memory (EEPROM), and the like. The display control ECU 10 implements various functions, for example, by the CPU executing a program stored in the storage unit. An external sensor 1 and a display 3 (display unit) are connected to the display control ECU 10. Note that the display control ECU 10 may be configured by using a plurality of electronic units.

The external sensor 1 is detection equipment that detects a situation around the vehicle. The external sensor 1 includes a camera (in-vehicle camera) 1a that captures an image of a view ahead of the vehicle. The camera 1a is image capturing equipment that captures an image of a view ahead of the vehicle. For example, the camera 1a is disposed on the back side of a windshield of the vehicle, and captures an image of a view ahead of the vehicle. Examples of the type of the camera 1a include a telephoto camera, a wide angle camera, a monocular camera, a stereo camera, and the like. The stereo camera includes two image capturing units that are arranged to reproduce binocular disparity. Image information captured by the stereo camera includes information in a depth direction. The camera 1a transmits information related to the captured image to the display control ECU 10.

The external sensor 1 may include a radar sensor. The radar sensor is detection equipment that detects an object around the vehicle by using radio waves (for example, millimeter waves) or light. The radar sensor detects an object by sending out radio waves or light around the vehicle and receiving radio waves or light reflected by the object. Examples of the radar sensor include light detection and ranging (LiDAR) 1b, a millimeter-wave radar 1c, and the like. The radar sensor may acquire a value of measured distance to an object (another vehicle or the like) around the vehicle. The radar sensor transmits, to the display control ECU 10, information on the detected object and information on the acquired value of measured distance. In the description below, at least one of the LiDAR 1b and the millimeter-wave radar 1c is simply referred to as “radar sensor 1b, 1c” collectively.

An internal sensor 2 is detection equipment that detects a traveling state of the vehicle. The internal sensor 2 includes a vehicle speed sensor, an accelerometer, and a yaw rate sensor. The vehicle speed sensor is a detector that detects the speed of the vehicle. The vehicle speed sensor transmits detected vehicle speed information (wheel speed information) to the display control ECU 10.

The accelerometer is a detector that detects the acceleration of the vehicle. The accelerometer includes at least a lateral accelerometer that detects a lateral acceleration that is an acceleration in a vehicle-width direction of the vehicle. The accelerometer transmits detected acceleration information to the display control ECU 10.

The yaw rate sensor is a detector that detects the yaw rate (angular velocity) around a vertical axis at the center of gravity of the vehicle. For the yaw rate sensor, for example, a gyroscope sensor can be used. The yaw rate sensor transmits detected vehicle yaw rate information to the display control ECU 10.

The display 3 is an in-vehicle display provided in a vehicle cabin of the vehicle. As an example of the display 3, a head up display (HUD) is used. For example, the display 3 may be configured as an AR-HUD, which casts an image onto a display face of the front windshield by using augmented reality (AR) technology or the like. A display area of the head up display is a preset area in the front windshield, and is a range in which a virtual image is cast and displayed in a superimposed manner. The display 3 is controlled in such a manner as to display various kinds of information according to a control signal from the display control ECU 10. An image representing a situation ahead of the vehicle is displayed on the display 3, with virtual image, including a vehicle image representing another vehicle, superimposed on the image. Note that the display 3 is not limited to the HUD. Other than the HUD, a liquid crystal display installed in front of the driver in an instrument panel, or a liquid crystal display of a navigation system, may be used for the display 3.

Next, a functional configuration of the display control ECU 10 is described. The display control ECU 10 includes a recognition and generation section 11 and a display control section 12.

The recognition and generation section 11 recognizes a lane marking, based on an image captured by the camera 1a of the vehicle. As an example of the lane marking, the recognition and generation section 11 recognizes a pair of right and left white lines extending in such a manner as to demarcate a lane (own lane) in which the vehicle is traveling. Note that the lane marking that is recognized by the recognition and generation section 11 is not limited to the pair of right and left white lines, and may be any one of the white lines, or may be any other lane marking that extends along the own lane. The recognition and generation section 11 can recognize the lane marking, for example, by performing commonly known image recognition, such as by deep learning, on an image captured by the camera 1a.

The recognition and generation section 11 recognizes a lane marking position of the lane marking, based on the image captured by the camera 1a of the vehicle. The lane marking position is a position of the lane marking in an image for display, to present the lane marking in the image for display. The lane marking position may be, for example, the x, y coordinates of a point corresponding a position of the lane marking, in an x, y coordinate system for the image for display. The lane marking position may be a series of coordinates corresponding to the positions of individual points in a point cloud that constitutes the lane marking in the image for display.

For example, the recognition and generation section 11 recognizes a reference lane marking position as a lane marking position. The reference lane marking position is, for example, the position of a corresponding road shape image on a predetermined plane on which the vehicle is present in the image for display. The predetermined plane refers to a plane serving as a reference when the image is displayed, and may be assumed to be, for example, a level surface (plane that has no slope) on which the vehicle is present. In other words, there are some cases where the road surface of the own lane is not parallel with the predetermined plane, such as when the road surface of the own lane has slope (cant) in a lane-width direction.

The recognition and generation section 11 generates an image for display. The image for display is an image to be displayed on the display 3. For example, the image for display may be an image corresponding to the entire display area of the display 3, such as an image presenting a scenery ahead that the driver is seeing through the windshield of the vehicle. When the display 3 is a HUD, the image for display may be a virtual image to be superimposed.

The image for display includes a road shape image that is disposed along the lane marking. The road shape image is an image for conceptually presenting a road shape extending along the lane marking in the image for display. For example, the road shape image can be a line segment or a plurality of icon images, such as polygons or circles, that indicates the road surface of the own lane and is disposed along the lane marking in the image for display. For example, the road shape image may be a straight line or a curve that indicates the road surface of the own lane and extends along the lane marking in the image for display. The road shape image can be drawn along a series of the lane marking positions recognized. The recognition and generation section 11 generates the road shape image, based on the recognized lane marking positions.

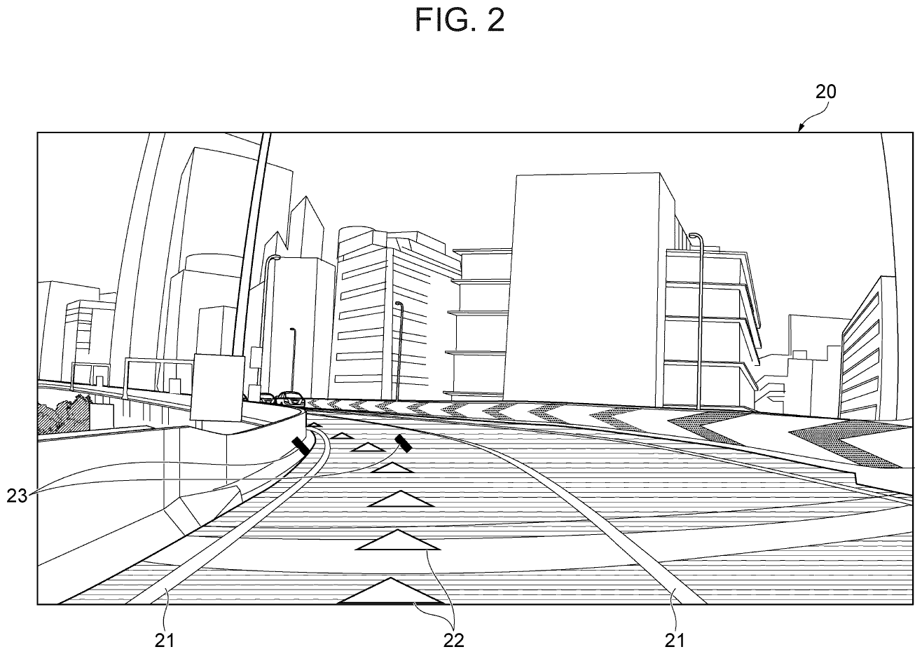

FIG. 2 is a diagram for describing misalignment of lane markings in an image for display. FIG. 2 shows an image for display 20 that presents a scene in which the vehicle is traveling a left-hand curve on an expressway, as an example of a scenery ahead of the vehicle. In FIG. 2, the image for display 20 is a virtual image projected onto the windshield of the vehicle, and is superimposed on the scenery ahead of the vehicle that the driver is seeing through the windshield. A pair of lane markings 21 is present in the actual scenery ahead of the vehicle. Accordingly, when the image for display 20 including road shape images is superimposed on the actual scenery and displayed, an error in display of the road shape images (error in lane marking positions) corresponds to an amount of misalignment with respect to the actual lane markings 21 in FIG. 2.

In FIG. 2, a plurality of LKA marks 22 (road shape images) arranged along the own lane is images that are included in the image for display 20 and superimposed on the scenery ahead, and images displayed for the LKA control described above. Each LKA mark 22 may be, for example, a triangle oriented in such a manner that one vertex points in a traveling direction of the vehicle. The LKA marks 22 may be arranged along a virtual line representing a target trajectory at predetermined intervals. The recognition and generation section 11 can calculate the trajectory for the LKA marks 22 by using a commonly known road shape model. The road shape model may be, for example, a clothoid model. For example, based on the lane markings and the reference lane marking position that are recognized, the recognition and generation section 11 can calculate curvatures of the lane markings, amounts of change in the curvatures of the lane markings, amounts of offset (lateral positions) of the lane markings from a predetermined reference point (for example, the origin) in the image for display 20, relative angles (angles in a yaw direction) between the lane markings and the vehicle, and the like, and can calculate the trajectory for the LKA marks 22 by using the calculated values. In other words, the LKA marks 22 are calculated based on the reference lane marking position. Note that the LKA marks 22 may have a graphic form other than a triangle, or may be an image of a continuous or broken line.

The recognition and generation section 11 can calculate a position of a pair of LDW marks 23 (road shape images) as in the method of calculating the trajectory for the LKA marks 22. The LDW marks 23 are images that are included in the image for display 20 and superimposed on the scenery ahead, and are images displayed for the LDW control, in such a manner as to correspond to the positions of the lane markings. The LDW marks 23 are calculated also based on the reference lane marking position. For example, the LDW marks 23 can be images of line segments that are approximately parallel with the directions of tangent lines to the lane markings of the own lane at a position corresponding to a predetermined distance ahead of the vehicle. In the example in FIG. 2, the LDW marks 23 are displayed in a pair in such a manner as to correspond to the positions of the lane markings on the both right and left edges of the own lane. An LDW mark 23 may be displayed in such a manner as to correspond to the position of one lane marking on one side (for example, where the vehicle is likely to depart from the own lane) of the right and left sides of the own lane.

Here, the left-hand curve in FIG. 2 has such a cant that the road surface of the own lane is lower on the left side in the lane-width direction and is higher on the right side. In a curve having a cant, there are some cases where the actual lane markings 21 are not present on the predetermined plane (level surface on which the vehicle is present). However, the reference lane marking position recognized by the recognition and generation section 11 is recognized as a corresponding position on the predetermined plane. Accordingly, in some cases, the actual lane marking 21 on the right side is erroneously recognized in such a manner that the distance from the vehicle seems to be longer than the actual distance, and the actual lane marking 21 on the left side is erroneously recognized in such a manner that the distance from the vehicle seems to be shorter than the actual distance.

Accordingly, the LKA marks 22 and the LDW marks 23 are misaligned with the actual lane markings 21 in FIG. 2 in the lane-width direction, by using the reference lane marking position recognized from a captured image only as it is. In the LKA marks 22, such misalignment occurs that farther LKA marks 22 from the vehicle do not go along the actual lane markings 21. The LDW marks 23 are misaligned with the actual lane markings 21 in the lane-width direction. It can be thought that the misalignment of the LKA marks 22 and the LDW marks 23 with the actual lane markings 21 as described above occurs due to the effect of a recognition error of the camera 1a at a curve having a cant.

Accordingly, the display control section 12 estimates a cant angle of the lane, based on a result of detection by the internal sensor 2 that detects the traveling state of the vehicle, and corrects the positions of the road shape images in the image for display 20 by using the cant angle. As an example of the estimation of the cant angle, the display control section 12 uses the vehicle speed of the vehicle, the lateral acceleration of the vehicle, and the yaw rate of the vehicle for the traveling state of the vehicle, and estimates a cant angle θ of the lane at the position of the vehicle, based on an equation of motion that represents the balance between lateral force involved in a turn of the vehicle and lateral force acting on the vehicle due to the cant of the lane.

A lateral force Fy1 involved in a turn of the vehicle is the product of a mass m of the vehicle and a centrifugal acceleration a of the vehicle. Since the centrifugal acceleration a is equal to the product of a vehicle speed v of the vehicle and an angular velocity ω of the vehicle, the lateral force Fy1 is equal to the product of the mass m of the vehicle, the vehicle speed v of the vehicle, and the angular velocity ω of the vehicle. Note that a suffixed letter “y” means the y axis in the vehicle-width direction in a coordinate system based on the vehicle.

A lateral force Fy2 acting on the vehicle due to the cant of the lane can be calculated by approximating a state where the vehicle is positioned, facing in the direction of a tangent line, at a curve with a cant angle θ, to resolution of gravity on a simple sloped surface. In the vehicle-width direction, Fy2 is equal to the product of the mass m of the vehicle, an acceleration of gravity g, and sin 0.

By formulating an equation of motion that represents the balance between a lateral force Fy corresponding to a lateral acceleration ay detected by the internal sensor 2 of the vehicle, the lateral force Fy1, and the lateral force Fy2, substituting the lateral force Fy with the product of the mass m of the vehicle and the lateral acceleration ay, which is equal to the lateral force Fy, and then rearranging the equation to make the cant angle θ the subject, the following expression (1) can be obtained. The cant angle θ here is based on the traveling state of the vehicle, and therefore refers to a cant angle at the position of the vehicle. Accordingly, by using the expression (1), the cant angle θ at the position of the vehicle can be estimated based on the vehicle speed v of the vehicle, the angular velocity ω of the vehicle, and the lateral acceleration ay.

$$Cant angle : θ = {sin}^{- 1} ( \frac{vw - {a}_{y}}{g} ) \qquad expression ( 1 )$$

For example, assuming that the reference lane marking position is recognized in a captured image that is captured by the camera 1a in a horizontal pose, the display control section 12 corrects the positions of the road shape images in the image for display 20, by calculating a clothoid parameter by using the estimated cant angle θ such that a situation is simulated in which the pose of the camera 1a changes in a roll direction according to the cant angle θ. The positions of the road shape images refer to the positions of the LKA marks 22 and the LDW marks 23 in the example in FIG. 2. For the position of a road shape image, with regard to the images of the LKA marks 22 that are discretely arranged, a predetermined position in the triangle image (for example, the coordinates of one vertex) of each LKA mark 22 may be used. For the position of a road shape image, with regard to the line segment images of the LDW marks 23, a predetermined position in the image of each LDW mark 23 (for example, the coordinates of the middle of each line segment) may be used.

The display control section 12 may convert the reference lane marking position on the level surface on which the vehicle is present, into an estimated lane marking position on a plane with the cant angle θ, by matrix calculation as in the following expression (2). Note that in the expression (2), X, Y, Z represent the reference lane marking position (in the world coordinate system) on the level surface on which the vehicle is present; Ex, Ey, Ez represent an amount of transitional offset, indicating components by which the camera 1a is mounted off a predetermined reference position on a vehicle layout; a, b, c, . . . , h, i are components of rotation (corresponding to amounts of roll) of the camera 1a, calculated from the cant angle θ; ox, oy are the x, y coordinates of the center of the image for display 20; f is the focal length of the camera 1a; kx, ky represent the size of one pixel; and x, y, z represent the estimated lane marking position (in the world coordinate system) on the plane with the cant angle θ.

$$( \begin{matrix}x \\ y \\ z \\ 1\end{matrix} ) = ( \begin{matrix}\frac{f}{kx} & 0 & ox & 0 \\ 0 & \frac{f}{ky} & 0 & oy \\ 0 & 0 & 1 & 0 \\ 0 & 0 & 0 & 1\end{matrix} ) ( \begin{matrix}a & b & c & Ex \\ d & e & f & Ey \\ g & h & i & Ez \\ 0 & 0 & 0 & 1\end{matrix} ) ( \begin{matrix}X \\ Y \\ Z \\ 1\end{matrix} ) \qquad expression ( 2 )$$

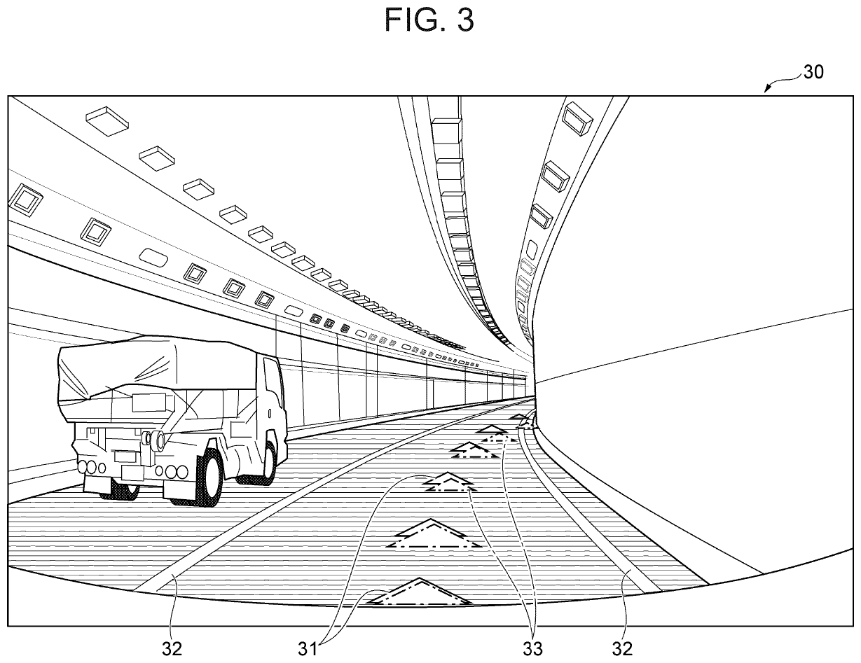

The display control section 12 causes the display 3 of the vehicle to display the image for display. FIG. 3 shows an example of correction of the positions of lane markings in an image for display. FIG. 3 shows an image for display 30 that presents a scene in which the vehicle is traveling a right-hand curve in a tunnel on an express way, as another example of a scenery ahead of the vehicle. In FIG. 3, the image for display 30 including LKA marks 31 (road shape images) is also a virtual image projected onto the windshield of the vehicle and superimposed on the scenery ahead of the vehicle that the driver is seeing through the windshield. A pair of actual lane markings 32 is present in the actual scenery ahead of the vehicle. Each LKA mark 31 is, for example, a triangular image similar to the LKA marks 22 in FIG. 2, and is indicted by a solid line in the example in FIG. 3.

In the example in FIG. 3, the positions of the solid LKA marks 31 are positions corrected by the display control section 12 by using the cant angle θ estimated as described above. On the other hand, the positions of LKA marks 33 are positions that are not corrected by the display control section 12 and are calculated by using a reference lane marking position recognized from a captured image as it is. Each LKA mark 33 is, for example, a triangular image similar to the LKA marks 22 in FIG. 2, and is indicted by a dash-dotted line in the example in FIG. 3. As shown in FIG. 3, by performing correction to the positions of the LKA marks 31 by using the estimated cant angle θ, an amount of misalignment with the pair of actual lane markings 32 can be reduced, compared to the positions of the LKA marks 33. Note that the dash-dotted LKA marks 33 are depicted in FIG. 3 for comparison with the solid LKA marks 31. The actual image for display 30 may omit to include the LKA marks 33.

Incidentally, in a situation where the vehicle approaches a curve from a straight line, a large cant angle may be estimated in advance, to fit with the curve having the gradually increasing curvature. When the cant angle estimated at the position of the vehicle is less than a predetermined cant angle threshold value and when the rate of increase in curvature of the lane marking in a predetermined section ahead of the vehicle is a predetermined increase rate threshold value or more, the display control section 12 may estimate the cant angle in such a manner that the cant angle gradually increases as the lane goes farther ahead from the position of the vehicle. The cant angle threshold value is a threshold value of cant angle to determine whether a road surface at the position of the vehicle is of a straight line or of a curve. The increase rate threshold value is a threshold value of curvature increase rate (positive curvature change rate) to determine whether or not the road surface changes from that of a straight line to that of a curve forward of the position of the vehicle. The cant angle threshold value and the increase rate threshold value can be preset, for example, according to a predetermined road design standard or the like.

For example, the display control section 12 may estimate the cant angle in such a manner that the cant angle gradually increases as the lane goes farther ahead from the position of the vehicle, by using the cant angle θ estimated at the position of the vehicle as a base and adding a predetermined addend cant angle with each predetermined distance forward of the position of the vehicle. The predetermined distance and the addend cant angle are correction parameters to estimate cant angles that fit with a curve having the gradually increasing curvature. The predetermined distance and the addend cant angle can be preset through an actual vehicle test, simulation, or the like, according to a timing when a condition is satisfied for estimating the cant angle in such a manner that the cant angle gradually increases, as well as according to changes over time in the curvature of a curve after the timing.

Similarly, in a situation where the vehicle approaches a straight line from a curve, a small cant angle may be estimated in advance, to fit with the curve having the gradually decreasing curvature. When the cant angle estimated at the position of the vehicle is the predetermined cant angle threshold value or more and when the rate of decrease in curvature of the lane marking in the predetermined section is a predetermined decrease rate threshold value or more, the display control section 12 may estimate the cant angle in such a manner that the cant angle gradually decreases as the lane goes farther ahead from the position of the vehicle. The decrease rate threshold value is a threshold value of curvature decrease rate (negative curvature change rate) to determine whether or not the road surface changes from that of a curve to that of a straight line forward of the position of the vehicle. The decrease rate threshold value can be preset, for example, according to the predetermined road design standard or the like.

For example, the display control section 12 may estimate the cant angle in such a manner that the cant angle gradually decreases as the lane goes farther ahead from the position of the vehicle, by using the cant angle estimated at the position of the vehicle as a base and subtracting a predetermined subtrahend cant angle with each predetermined distance forward of the position of the vehicle. The predetermined distance and the subtrahend cant angle are correction parameters to estimate cant angles that fit with a curve having the gradually increasing curvature. The predetermined distance and the subtrahend cant angle can be preset through an actual vehicle test, simulation, or the like, according to a timing when a condition is satisfied for estimating the cant angle in such a manner that the cant angle gradually decreases, as well as according to changes over time in the curvature of a curve after the timing.

Note that when a situation is neither a situation where the vehicle approaches a curve from a straight line nor a situation where the vehicle approaches a straight line from a curve as described above, the cant angle θ estimated at the position of the vehicle may be used as it is.

### Processing by Display Control ECU

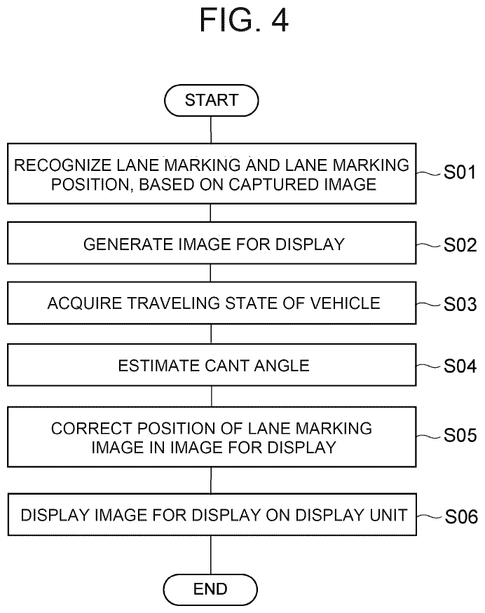

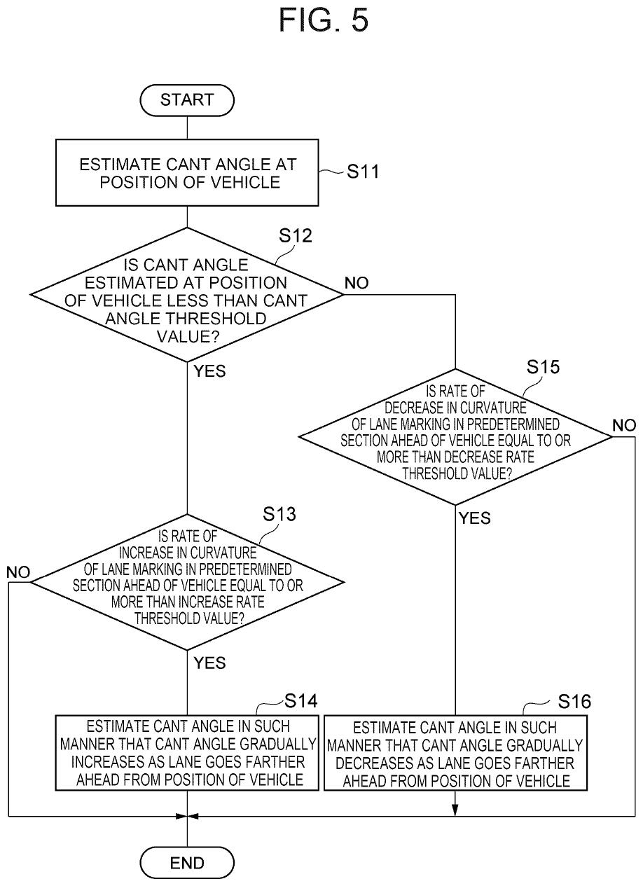

Next, an example of processing by the display control ECU 10 is described with reference to FIGS. 4 and 5. FIG. 4 is a flowchart showing an example of processing by the display system according to the embodiment. FIG. 5 is a flowchart showing an example of a process of estimating a cant angle in FIG. 4. For example, the processing shown in FIG. 4, FIG. 5 is performed in a predetermined cycle repeatedly while the display control ECU 10 is operating.

As shown in FIG. 4, in S01, the display control ECU 10 performs recognition of a lane marking and a lane marking position based on a captured image, through the recognition and generation section 11. The recognition and generation section 11 recognizes the lane marking, based on the image captured by the camera 1a. The recognition and generation section 11 recognizes the lane marking position of the lane marking, based on the image captured by the camera 1a of the vehicle. For example, the recognition and generation section 11 recognizes a reference lane marking position as a lane marking position.

In S02, the display control ECU 10 performs generation of an image for display, through the recognition and generation section 11. For example, the recognition and generation section 11 generates the image for display including a road shape image indicating the lane marking, by using the reference lane marking position.

In S03, the display control ECU 10 performs acquisition of a traveling state of the vehicle, through the display control section 12. For example, the display control section 12 acquires, as the traveling state of the vehicle, the vehicle speed of the vehicle, the lateral acceleration of the vehicle, and the yaw rate of the vehicle, based on a result of detection by the internal sensor 2.

In S04, the display control ECU 10 performs estimation of a cant angle, through the display control section 12. For example, the display control ECU 10 performs the process of estimating a cant angle shown in FIG. 5.

As shown in FIG. 5, in S11, the display control ECU 10 performs estimation of a cant angle at the position of the vehicle, through the display control section 12. For example, the display control section 12 estimates the cant angle at the position of the vehicle, according to the expression (1).

In S12, the display control ECU 10 performs determination of whether or not the cant angle estimated at the position of the vehicle is less than the cant angle threshold value, through the display control section 12. When the display control section 12 determines that the cant angle estimated at the position of the vehicle is less than the cant angle threshold value (S12: YES), the display control ECU 10 moves to S13.

In S13, the display control ECU 10 performs determination of whether or not the rate of increase in curvature of the lane marking in a predetermined section ahead of the vehicle is the increase rate threshold value or more, through the display control section 12. When the display control section 12 determines that the rate of increase in curvature of the lane marking in the predetermined section ahead of the vehicle is the increase rate threshold value or more (S13: YES), the display control ECU 10 moves to S14.

In S14, the display control ECU 10 estimates the cant angle in such a manner that the cant angle gradually increases as the lane goes farther ahead from the position of the vehicle, through the display control section 12. For example, the display control section 12 estimates the cant angle in such a manner that the cant angle gradually increases as the lane goes farther ahead from the position of the vehicle, by using the cant angle estimated at the position of the vehicle as a base and adding the predetermined addend cant angle with each predetermined distance forward of the position of the vehicle. Thereafter, the display control ECU 10 terminates the processing in FIG. 5 and returns to the processing in FIG. 4.

When the display control section 12 determines that the rate of increase in curvature of the lane marking in the predetermined section ahead of the vehicle is less than the increase rate threshold value (S13: NO), the display control ECU 10 terminates the processing in FIG. 5 and returns to the processing in FIG. 4.

When the display control section 12 determines that the cant angle estimated at the position of the vehicle is the cant angle threshold value or more (S12: NO), the display control ECU 10 moves to S15.

In S15, the display control ECU 10 performs determination of whether or not the rate of decrease in curvature of the lane marking in the predetermined section ahead of the vehicle is the decrease rate threshold value or more, through the display control section 12. When the display control section 12 determines that the rate of decrease in curvature of the lane marking in the predetermined section ahead of the vehicle is the decrease rate threshold value or more (S15: YES), the display control ECU 10 moves to S16.

In S16, the display control ECU 10 estimates the cant angle in such a manner that the cant angle gradually decreases as the lane goes farther ahead from the position of the vehicle, through the display control section 12. For example, the display control section 12 estimates the cant angle in such a manner that the cant angle gradually decreases as the lane goes farther ahead from the position of the vehicle, by using the cant angle estimated at the position of the vehicle as a base and subtracting the predetermined subtrahend cant angle with each predetermined distance forward of the position of the vehicle. Thereafter, the display control ECU 10 terminates the processing in FIG. 5 and returns to the processing in FIG. 4.

When the display control section 12 determines that the rate of decrease in curvature of the lane marking in the predetermined section ahead of the vehicle is less than the decrease rate threshold value (S15: NO), the display control ECU 10 terminates the processing in FIG. 5 and returns to the processing in FIG. 4.

As described hereinabove, according to the display system 100, the lane markings 21 are recognized based on the image captured by the camera 1a of the vehicle. In the image for display 20, the positions of the LKA marks 22 and the LDW marks 23 (road shape images) disposed along the recognized lane markings 21 are corrected by using the cant angle θ of the lane that is estimated based on a result of detection by the internal sensor 2 that detects a traveling state of the vehicle. Thus, it is possible to restrain misalignment of the road shape images in the image for display 20 acquired as a result of image recognition using the camera 1a, while reducing an increase in cost, for example, compared to cases where a high-definition map is used.

In the display system 100, the display control section 12 uses the vehicle speed v of the vehicle, the lateral acceleration ay of the vehicle, and the angular velocity ω of the vehicle for the traveling state of the vehicle, and estimates the cant angle θ of the lane at the position of the vehicle, based on the equation of motion that represents the balance between the lateral force Fy1 involved in a turn of the vehicle, the lateral force Fy2 acting on the vehicle due to the cant of the lane, and the lateral force Fy corresponding to the lateral acceleration of the vehicle, for example, by using the expression (1). Thus, by using the cant angle θ estimated at the position of the vehicle by using the vehicle speed v of the vehicle, the lateral acceleration ay of the vehicle, and the angular velocity ω of the vehicle, it is possible to correct the positions of the LKA marks 22 and the LDW marks 23 in the image for display 20.

In the display system 100, when the cant angle θ estimated at the position of the vehicle is less than the predetermined cant angle threshold value and when the rate of increase in curvature of the lane markings 21 in the predetermined section ahead of the vehicle is the predetermined increase rate threshold value or more, the display control section 12 estimates the cant angle in such a manner that the cant angle gradually increases as the lane goes farther ahead from the position of the vehicle. Thus, for example, in a situation where the vehicle approaches a curve from a straight line, a large cant angle can be estimated in advance, to fit with the curve having the gradually increasing curvature. When the cant angle θ estimated at the position of the vehicle is the predetermined cant angle threshold value or more and when the rate of decrease in curvature of the lane markings 21 in the predetermined section is the predetermined decrease rate threshold value or more, the cant angle is estimated in such a manner that the cant angle gradually decreases as the lane goes farther ahead from the position of the vehicle. Thus, for example, in a situation where the vehicle approaches a straight line from a curve, a small cant angle can be estimated in advance, to fit with the curve having the gradually decreasing curvature.

Although an embodiment of the present disclosure has been described hereinabove, the present disclosure is not limited to the embodiment.

In the embodiment, in a situation where the vehicle approaches a curve from a straight line, the display control section 12 estimates a large cant angle in advance that fits with the curve having the gradually increasing curvature. However, such a process is not essential. In a situation where the vehicle approaches a straight line from a curve, the display control section 12 estimates a small cant angle in advance that fits with the curve having the gradually decreasing curvature. However, such a process is not essential. For example, for cant angles, the cant angle θ estimated at the position of the vehicle may be used uniformly.

In the embodiment, the display control section 12 estimates the cant angle θ of the lane at the position of the vehicle, for example, by using the expression (1). However, such an example is not essential. The cant angle of the lane at the position of the vehicle may be estimated according to an expression other than the expression (1). Moreover, it is not essential for the estimation of the cant angle θ to use the vehicle speed v of the vehicle, the lateral acceleration ay of the vehicle, and the angular velocity ω of the vehicle for the traveling state of the vehicle, and to be based on the equation of motion that represents the balance between the lateral force involved in a turn of the vehicle and the lateral force acting on the vehicle due to the cant of the lane. For example, any one or two of the vehicle speed of the vehicle, the lateral acceleration of the vehicle, and the yaw rate of the vehicle may be used for the traveling state of the vehicle, and any other physical amount that represents a traveling state of the vehicle may be used.

What is claimed is:

1. A display system configured to display, on an in-vehicle display, a lane marking of a lane in which a vehicle travels, the display system comprising:
a recognition and generation section configured to recognize the lane marking, based on an image captured by an in-vehicle camera of the vehicle, and to generate an image for display including a road shape image disposed along the lane marking; and
a display control section configured to cause a display unit of the vehicle to display the image for display,
wherein the display control section is configured to estimate a cant angle of the lane, based on a result of detection by an internal sensor that detects a traveling state of the vehicle, and to correct, by using the cant angle, a position of the road shape image in the image for display.

2. The display system according to claim 1, wherein the display control section is configured to use a vehicle speed of the vehicle, a lateral acceleration of the vehicle, and a yaw rate of the vehicle for the traveling state of the vehicle, and to estimate the cant angle of the lane at a position of the vehicle, based on an equation of motion that represents a balance between lateral force involved in a turn of the vehicle, lateral force acting on the vehicle due to a cant of the lane, and lateral force corresponding to the lateral acceleration of the vehicle.

3. The display system according to claim 2, wherein the display control section is configured to:
when the cant angle estimated at the position of the vehicle is less than a predetermined cant angle threshold value and when a rate of increase in curvature of the lane marking in a predetermined section ahead of the vehicle is a predetermined increase rate threshold value or more, estimate the cant angle in such a manner that the cant angle gradually increases as the lane goes farther ahead from the position of the vehicle; and
when the cant angle estimated at the position of the vehicle is the cant angle threshold value or more and when a rate of decrease in curvature of the lane marking in the predetermined section is a predetermined decrease rate threshold value or more, estimate the cant angle in such a manner that the cant angle gradually decreases as the lane goes farther ahead from the position of the vehicle.
